(19) United States
(12) Patent Application Publication
(10) Pub. No.: US 2016/0252805 A1
(43) Pub. Date: Sep. 1, 2016

(54) OPTICAL DEVICE FOR CAPTURING IMAGES IN A 360° HORIZONTAL FIELD OF VIEW

(71) Applicant: GIROPTIC, Lille (FR)

(72) Inventor: Richard OLLIER, La Madeleine (FR)

(21) Appl. No.: 15/027,597

(22) PCT Filed: Oct. 1, 2014
(86) PCT No.: PCT/FR2014/052489

§ 371 Date: Apr. 6, 2016

(30) Foreign Application Priority Data
Oct. 7, 2013 (FR) 1359718

(51) Int. Cl. G03B 37/04; H04N 5/232

(52) U.S. Cl. CPC G03B 37/04; H04N 5/23238

(57) ABSTRACT

An optical device (1) for capturing images, covering a 360° field by digital pasting of three images, including three lens groups (2,3,4) with a longitudinal axis for acquisitions of the three images respectively, each lens group including a head lens (21,31,41), followed by several lenses along the same longitudinal axis of the lens group, so as to project the transmitted rays to an image sensor (22,32,42), the three lens groups (2,3,4) being arranged around a dummy rotation axis (5) and in which the lens groups are positioned in a triangular geometric configuration along the direction of the dummy rotation axis, the lens groups (2,3,4) being arranged without overlapping with each other, and the angle of inclination between the longitudinal axis of each lens group (2;3;4) and the plane orthogonal to the dummy rotation axis (5) being greater than or equal to 0° and less than 15°.

### TECHNICAL DOMAIN AND PRIOR ART

The invention relates to an optical device for capturing images covering a 360° field by digital pasting of three images.

This invention is used in many advantageous applications, particularly in fields of sport to acquire a 360° video, particularly for descent and sliding sports for example such as skiing, surfing, and cycling.

Other advantageous applications may be envisaged within the framework of this invention, for example acquisition of 360° overhead video by drones.

It is known that a 360° horizontal field of view can be obtained in the field of image capture by juxtaposition and then digital pasting of images obtained from several lenses.

The Applicant, particularly in document WO2012/032236A1, discloses an optical device for 360° image capture, by digital pasting of three images.

Such a device comprises three groups of lenses with a longitudinal axis for acquisitions of said three images; according to such a device, each lens group has a head lens followed by several lenses along the same longitudinal axis of the lens group, so as to project the transmitted rays to an image sensor.

In this prior art, the lens groups are positioned in a triangular geometric configuration around a dummy rotation axis (see FIG. 1 appended to this description).

A dummy rotation axis means that the position of one of the lens groups may be obtained from one of the other two lens groups of the device after transformation of rotation in space about an axis corresponding to this dummy rotation axis.

Typically, the relative positions of the three lens groups are obtained by successive rotations of 120°, the triangle formed by the three lens groups being an equilateral triangle.

According to the optical device described in this document, the three lens groups necessarily overlap each other around this dummy rotation axis.

Thus, the longitudinal axis of each lens group is inclined from a plane orthogonal to the dummy rotation axis, so that the lens groups can be overlapped (see FIGS. 2 and 3 appended to this description).

Such overlapping can bring the lens groups closer to each other and thus reduce the distance between no-parallax points in each lens group.

The reduction in the distance between no-parallax points makes it possible to have good juxtaposition of the three images after pasting.

In the field of panoramic photography, it is worth recalling that the no parallax point is considered as being the convergence point of incident light rays that pass through the head lens, if they had not been deviated by the head lens; in this case, it is the centre of the inlet pupil.

Therefore good juxtaposition of acquired images after pasting requires that the distance between no-parallax points should be reduced; in document WO 2012/032236A1, this reduction necessarily requires overlapping that is made possible by an inclination of lens groups; the lens groups used up to now have been too large.

According to the example in FIG. 2 in document WO 2012/032236A1 and as shown in FIG. 1 appended to this description, the difference in distance between any two no-parallax points is 22 mm, and up to now it has been impossible to reduce this difference.

Furthermore, the angle of inclination between the longitudinal axis of each lens group and the plane orthogonal to said dummy rotation axis, that can be used to overlap lens groups, is typically between 15° and 30°.

It should be noted that the dimensions of <<wide angle>> lens groups used up to now has made it impossible to reduce this inclination.

Such a portable device is marketed by the Applicant under the name “GIROCAM” (http://www.girocam.com/) and is capable of giving a 360° image acquisition and very good quality digital pasting.

However, since the groups have to be inclined to enable overlapping, the inventor has observed that with such a device, it is impossible to acquire a vertical field of view over the entire height, namely an elevation of the optical field varying from +90° to −90°.

In the best case, for an angle of inclination of 15° between the axis of the lens group and the plane orthogonal to said dummy rotation axis, the elevation after the three images have been pasted only extends between −50° and +90°, giving a vertical field of view of 140° (see FIG. 5 appended to this description), which represents a significant loss of information.

This is not altogether satisfactory; acquisition of a vertical field of view reaching 180° is preferable to capture the entire scene, and thus prevent loss of information in the captured scene.

The only way to broaden the acquired vertical field of view is to reduce the angle of inclination.

However, it is impossible to reduce this angle of inclination further due to the necessary overlapping of lens groups with each other (for juxtaposition of images after pasting).

As can be seen in FIG. 3 appended to this description, this angle cannot be reduced considering the mechanical blockage between the adjacent ends of two successive lens groups; as shown in this FIG. 3, the head lens of a first lens group is blocked by the image sensor of a second group, which prevents inclination of the lens group.

Therefore, the Applicant has observed that a satisfactory vertical field of view cannot be obtained with the current configuration of the optical device described above.

### SUMMARY AND PURPOSE OF THIS INVENTION

This invention aims at improving the situation described above.

Thus, one of the purposes of this invention is to overcome the above-mentioned disadvantages by disclosing a device for capturing images with a 360° horizontal field of view and a vertical field of view that is better than is possible in the state of the art.

One other purpose of this invention is to reduce the current size of the optical device disclosed in document WO 2012/032236A1.

Other purposes and advantages of this invention will become clear after reading the following description that is given for information and that is not in any way limitative.

Therefore according to a first of its aspects, this invention relates to an optical device for capturing images with a 360° field (in other words, a field for which the horizontal section covers) 360°, by digital pasting of three images.

According to this invention, the optical device comprises three lens groups with a longitudinal axis for corresponding acquisitions of the three images.

Preferably, each lens group comprises a head lens, followed by several lenses to project the transmitted rays to an image sensor, on the same longitudinal axis of the lens group; said three lens groups are arranged around a dummy rotation axis and the lens groups are positioned along the direction of this dummy rotation axis in a triangular geometric configuration.

This triangular configuration (as seen from above) can reduce the distance between no-parallax points.

Reducing this distance between no-parallax points is characteristic of this invention; it can give good juxtaposition of images when they are pasted.

According to the invention, the lens groups are arranged without overlapping with each other, and the angle of inclination between the longitudinal axis of each lens group and the plane orthogonal to said dummy rotation axis is:

greater than or equal to 0°, and

less than 15°.

This advantageous configuration without overlapping with small lens groups and with a small angle of inclination can significantly broaden the vertical field of view, which was not possible in the past in the state of the art, and particularly in document WO 2012/032236A1.

According to optional characteristics of the invention, taken alone or in combination:

the angle of inclination between the longitudinal axis of each lens group and the plane orthogonal to said dummy rotation axis is approximately of the order of between 1° and 14°, and preferably between 6° and 12° (optionally between 8° and) 10°):

each image sensor has an active area smaller than or inscribed in a 4 mm by 3 mm area;

for each lens group, the distance between the front face of the head lens and the image sensor associated with said lens group is less than or equal to 25 mm;

the difference in distance between no-parallax points of any two of said lens groups is less than or equal to 20 mm, and preferably less than or equal to 15 mm;

the relative positions of the three lens groups are obtained by successive rotations of 120° about the dummy rotation axis;

the device according to this invention is portable, and has one face on which the device can be supported on a horizontal surface by positioning said dummy rotation axis along the vertical direction.

According to a first embodiment, the pixels of image sensors are rectangular areas with dimensions 5 μm to 7 μm, for example 6 μm square areas, and the focal distance of each lens group is less than 2.5 mm and the difference in distance between no-parallax points of any two of said lens groups is less than or equal to 15 mm.

Alternately, according to a second embodiment, pixels of image sensors are rectangular areas with dimensions 2 μm to 4 μm, for example 3 μm square areas, and the focal distance of each lens group is less than 3 mm and the difference in distance between no-parallax points of any two of said lens groups is less than or equal to 10 mm.

Alternately, according to a third embodiment, the pixels of image sensors are rectangular areas, particularly square areas with side dimensions smaller than 2 μm, and the difference in distance between no-parallax points of any two of said lens groups is less than or equal to 10 mm.

Thus, due to the different structural characteristics described above, this invention is capable of acquiring images with a horizontal field of view of 360°, and with a vertical field of view greater than 140°.

### BRIEF DESCRIPTION OF THE APPENDED FIGURES

Other characteristics and advantages of this invention will become clear after reading the following description with reference to the appended FIGS. 4 to 9, that illustrate several variant embodiments of it that are not in any way limitative and in which:

FIG. 4 diagrammatically shows a top view of a lens assembly of an optical device according to one advantageous embodiment of the invention.

FIGS. 5 and 6 each show a detailed diagrammatic view of one of the three lens groups in FIG. 4.

FIG. 9 is a diagram showing the vertical field of view of a 360° image after digital pasting of three images obtained by means of a device according to FIG. 1, in accordance with the state of the art, for an inclination between the longitudinal axis of each lens group and the plane perpendicular to said dummy rotation axis equal to 15°.

FIG. 7 is a diagram showing the vertical field of view of a 360° image after digital pasting of three images obtained by means of a device according to FIG. 3, in accordance with the invention for an inclination between the longitudinal axis of each lens group and the plane perpendicular to said dummy rotation axis equal to 0°.

FIG. 8 is a diagram showing the vertical field of view of a 360° image after digital pasting of three images obtained by means of a device according to FIG. 3, in accordance with the invention for an inclination between the longitudinal axis of each lens group and the plane perpendicular to said dummy rotation axis equal to 9°.

### DETAILED DESCRIPTION OF ONE EMBODIMENT OF THE INVENTION

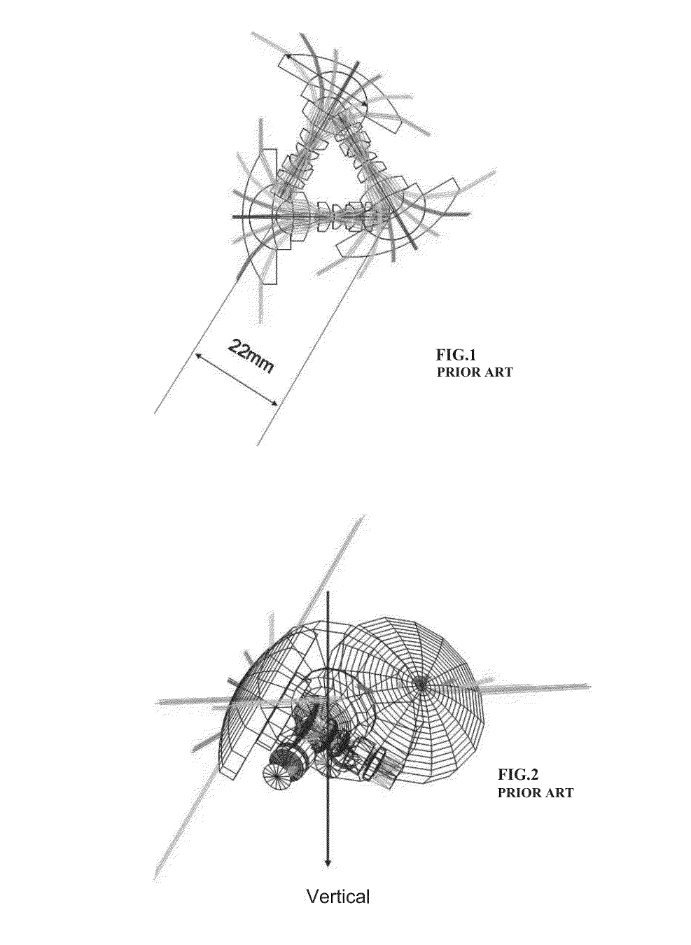

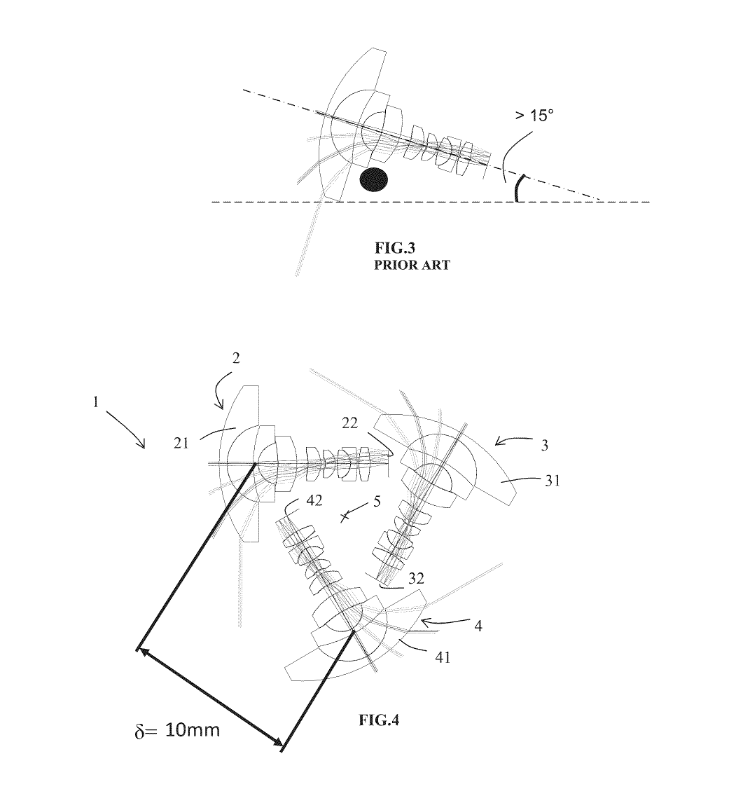

An optical device according to this invention will now be described with reference jointly to FIGS. 4 to 9.

One of the purposes of this invention is to design an optical device for acquisition of images with a 360° horizontal field of view and a vertical field of view larger than 140° (in other words between 140° and 180°.

As explained above in the description, document WO2012/032236A1 discloses an optical device for acquisition of 360° images and very good quality digital pasting, but with an unsatisfactory vertical field of view because it is less than 140°.

This invention is intended to overcome this problem and is particularly applicable to an optical device 1 for capturing images.

In a known manner, in the example described herein and as shown in FIG. 4, the optical device 1 according to this invention comprises three lens groups 2, 3 and 4 each of which can acquire an image at a given instant.

In the example described herein and as shown in FIG. 4, each lens group 2, 3 and 4 comprises a head lens 21, 31, 41; each head lens 21, 31, 41 is followed by the lens group 2, 3 and 4 by a plurality of lenses, on the same longitudinal axis A₂, A₃ and A₄.

As shown in FIG. 4, this arrangement for each lens group 2, 3 and 4 of a head lens 21, 31, 41, called a wide angle lens, followed by a plurality of lenses can project transmitted rays towards image sensors references 22, 32 and 42 respectively. More particularly, in the example described herein, each lens group 2, 3 and 4 is composed of a set of lenses with plane, spherical or aspherical surfaces for which the choices of material, thickness, curvature and position are determined by optimisation of an optical design composed of 2 lens sub-groups:

the front group (or frontal) that is divergent in nature to collect light rays on a wide field angle;

the rear group, with a divergent nature to focus light rays on the image sensor and forming the image on the image sensor.

Optical design properties of the lens groups 2, 3 and 4 is of the <<Fish-eye>> type and is distinguished by:

a very wide object field angle;

a focal distance approaching one millimetre;

a front group with negative power (diverging) and a rear group with positive power (converging);

a short optical path, (in this case of the order of 13 mm) with a short back focus (of the order of 3.5 mm),

one small frontal optical diameter (of the order of 20 mm),

the rear optical diameter of the same order of magnitude (of the order of 10 mm).

Thus, in the example described herein, the optical performances in terms of wave front quality are 0.6 lambda for all positions in the useful field of the image sensor, giving an optical FTM giving more than 50% contrast with a space frequency of Nyquist/2 for colour image sensor technologies based on a Bayer filter mosaic and with a pixel size of 1.4 um or similar giving a space frequency equal to Nyquist/2 with 125 pairs of lines/mm.

In the example described herein and as shown in FIG. 4, the three lens groups 2, 3 and 4 are arranged about a dummy rotation axis 5, and have a triangular geometric configuration (equilateral) about this axis 5.

In other words, as shown in FIG. 4, the so-called longitudinal axes of each of the three lens groups 2, 3 and 4 form a triangle. Such a configuration is characteristic of this invention. It can reduce the distance between no-parallax points.

The use of such a triangular arrangement of lens groups 2, 3 and 4 with wide angle head lenses 21, 31 and 41 can thus acquire a scene with a 360° horizontal field of view.

Preferably, the active area of each image sensor 22, 32 and 42 is smaller than or is inscribed in a 4 mm by 3 mm area, which can give good definition of acquired images.

According to a first characteristic of this invention, lens groups 2, 3 and 4 are arranged without any overlap; in other words, the lens groups 2, 3 and 4 do not overlap each other as can be seen in the state of the art shown in FIG. 2 in this description.

Furthermore, according to a second characteristic of this invention, the angle of inclination α between the longitudinal axis A₂, A₃ and A₄ of lens groups 2, 3 and 4 respectively and plane P, that is the plane orthogonal to the rotation axis 5, is greater than or equal to 0° and is less than 15°.

In the example described, this angle of inclination α is between 6° and 12°, and preferably between 8° and 10°.

The choice of a value of the angle of inclination α in this interval can give sufficient overlap with 175° lenses (simpler to make than 180° lenses).

The arrangement described above is characteristic of this invention.

Thus, in the example described herein and as shown in FIG. 4, with this arrangement, it is possible to obtain an optical device 1 with a distance difference δ between no-parallax points of any two lens groups equal to approximately 10 mm (compared with 22 mm in the state of the art).

Such a difference is particularly advantageous because it makes it possible to miniaturise the optical device 1 to limit its dimensions and for example to integrate it into a drone.

Maximising the vertical field of view is one of the objectives of this invention.

Thus, in the example described herein, and as shown in FIG. 7, when the angle of inclination α is equal to 0°, the vertical field of view is approximately equal to 180°, which is sufficient for complete acquisition of the scene both in the vertical field of view and the horizontal field of view.

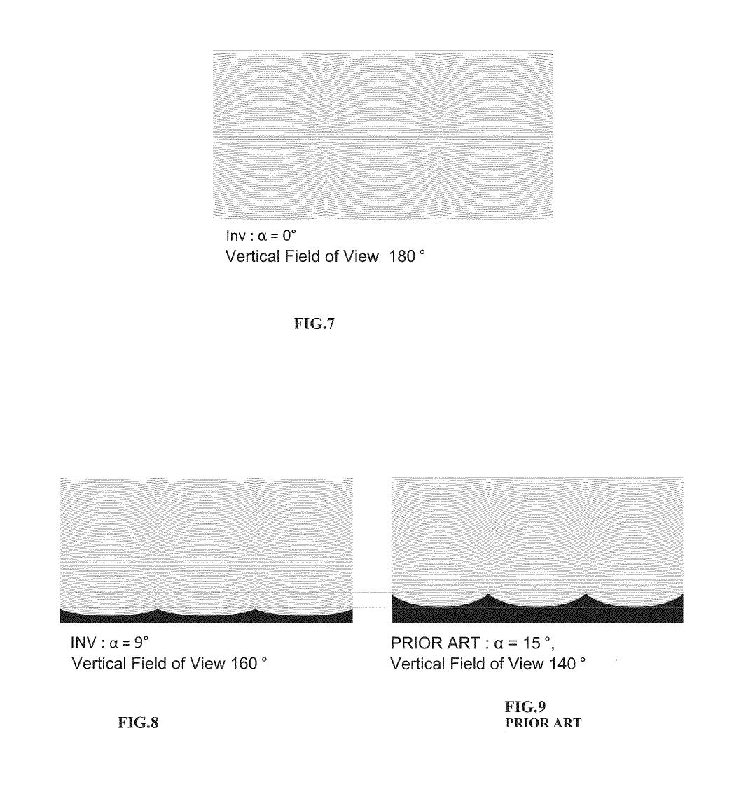

Alternately, as shown in FIG. 8, when the angle of inclination α is equal to 9°, the vertical field of view is equal to approximately 160°, which remains quite satisfactory in comparison with a 140° vertical field of view achieved with the optical device according to the state of the art (shown in FIG. 9).

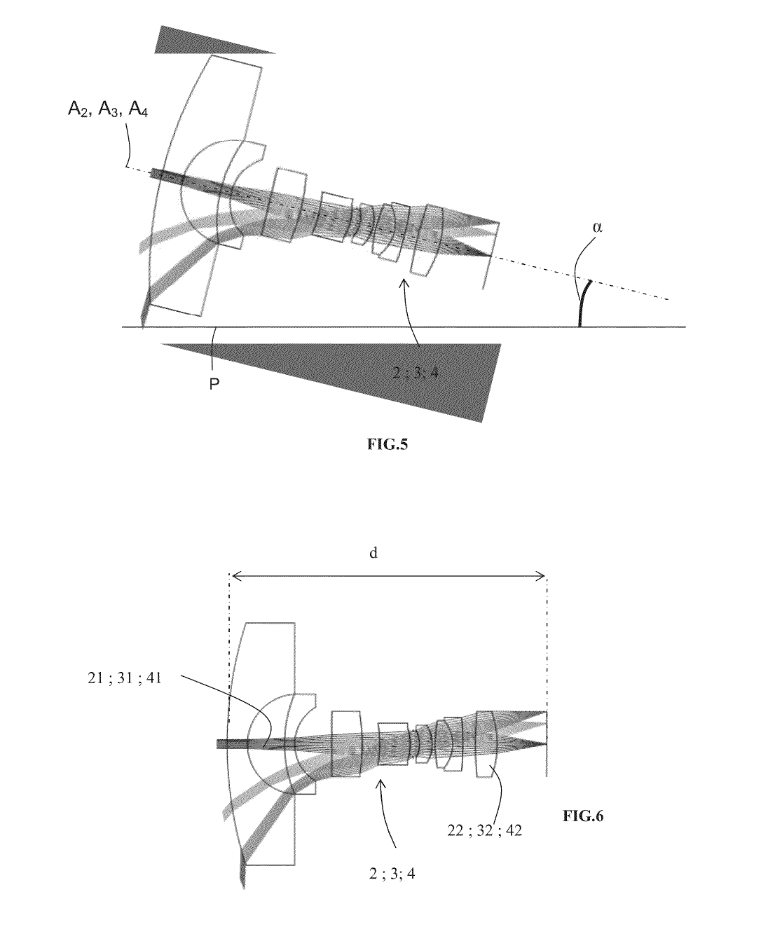

In the example described herein, and as shown in FIG. 6, for each lens group 2, 3 and 4, the distance d between the front face of the head lens 21, 31 and 41 and the associated image sensor 22, 32 and 42 is less than or equal to 25 mm; such a frontal distance can avoid overlapping of lens groups while enabling good juxtaposition of images after pasting.

Therefore, there is a direct relation between this frontal distance d and the difference δ between no-parallax points, such a relation possibly avoiding overlapping while guaranteeing good juxtaposition of images after pasting, which was not possible in the past according to the state of the art.

There is also a mathematical relation between the focal distance of the objective of each lens group and the distance between the no-parallax point and the axis of symmetry to determine the parallax error as a number of pixels; such a relation can be written according to the following equation:

$$P \approx \frac{f \cdot h \cdot sin ( θ )}{a \cdot d}$$

parallax error as a number of pixels

f focal distance of the objective

h no-parallax point—axis of symmetry distance

a pixel size

γparallax angle in radians

Thus, due to the different structural characteristics described above, this invention can overcome the above disadvantages of the state of the art, so that optical performances of the device can be improved while reducing its dimensions. Such improvements make a significant improvement to the possible field of applications for this invention, particularly with integration of the device in drones.

Obviously, other advantageous applications could be added.

It should be observed that this detailed description is applicable to one particular embodiment of this invention, but that this description is not in any way restrictive of the purpose of the invention; on the contrary, its purpose is to eliminate any confusion or poor interpretation of the following claims.

1. Optical device (1) for capturing images, covering a 360° field by digital pasting of three images, comprising three lens groups (2,3,4) with a longitudinal axis (A₂,A₃,A₄) for corresponding acquisitions of said three images, each lens group (2,3,4) comprising a head lens (21,31,41), followed by several lenses to project transmitted rays towards an image sensor (22,32,42) on the same longitudinal axis (A₂,A₃,A₄) of said lens group (2,3,4), said three lens groups (2,3,4) being arranged around a dummy rotation axis (5),
in which the lens groups (2,3,4) are positioned in a triangular geometric configuration, towards said dummy rotation axis (5), in which said lens groups (2,3,4) are arranged without overlapping with each other, and
in which the angle of inclination (α) between the longitudinal axis (A₂,A₃,A₄) of each lens group (2,3,4) and the plane (P) orthogonal to said dummy rotation axis (5) is greater than or equal to 0°, and less than 15°.

2. Device (1) according to claim 1, in which said angle of inclination (α) between the longitudinal axis (A₂,A₃,A₄) of each lens group (2,3,4) and the plane (P) orthogonal to said dummy rotation axis (5) is approximately of the order of between 1° and 14°.

3. Device (1) according to claim 1, in which said angle of inclination (α) between the longitudinal axis (A₂,A₃,A₄) of each lens group (2,3,4) and the plane (P) orthogonal to said dummy rotation axis (5) is approximately of the order of between 6° and 12°.

4. Device (1) according to claim 1, in which said angle of inclination (α) between the longitudinal axis (A₂,A₃,A₄) of each lens group (2,3,4) and the plane (P) orthogonal to said dummy rotation axis (5) is approximately of the order of between 8° and 10°.

5. Device (1) according to claim 1, in which the active area of each image sensor (22;32;42) is smaller than or is inscribed in a 4 mm by 3 mm area.

6. Device (1) according to claim 1 in which, for each lens group (2,3,4), the distance (d) between the front face of the head lens (21,31,41) and the image sensor (22,32,42) associated with said lens group (2,3,4) is less than or equal to 25 mm.

7. Device (1) according to claim 1, in which the difference (δ) in distance between any two no-parallax points of said lens groups (2,3,4) is less than or equal to 20 mm, preferably less than or equal to 15 mm.

8. Device (1) according to claim 7, in which the pixels of image sensors (22,32,42) are rectangular areas with dimensions 5 μm to 7 μm, for example 6 μm square areas, and in which the focal distance of each lens group (2,3,4) is less than 2.5 mm, and the difference in distance (δ) between no-parallax points of any two of said lens groups (2,3,4) is less than or equal to 15 mm.

9. Device (1) according to claim 7, in which the pixels of image sensors are rectangular areas with dimensions 2 μm to 4 μm, for example 3 μm square areas, and in which the focal distance of each lens group (2,3,4) is less than 3 mm, and the difference in distance (δ) between no-parallax points of any two of said lens groups (2,3,4) is less than or equal to 10 mm.

10. Device (1) according to claim 7, in which the pixels of image sensors (22,32,42) are rectangular areas, particularly square areas, with side dimensions less than 2 μm, and in which the difference in distance (δ) between no-parallax points of any two of said lens groups (2,3,4) is less than or equal to 10 mm.

11. Device (1) according to claim 1, in which the relative positions of the three lens groups (2,3,4) are obtained by successive rotations of 120°, about the dummy rotation axis.

12. Portable device (1) according to claim 1, having one face on which said device (1) can be supported on a horizontal surface by positioning said dummy rotation axis along the vertical direction.

13. Drone comprising an optical device (1) according to claim 1.

14. Method of obtaining at least one 360° image, which comprises:
providing an optical device according to claim 1; and
digitally pasting three images acquired by the three lens groups (2,3,4) respectively of said optical device (1).

15. Device (1) according to claim 2, in which said angle of inclination (α) between the longitudinal axis (A₂,A₃,A₄) of each lens group (2,3,4) and the plane (P) orthogonal to said dummy rotation axis (5) is approximately of the order of between 6° and 12°.

16. Device (1) according to claim 2, in which said angle of inclination (α) between the longitudinal axis (A₂,A₃,A₄) of each lens group (2,3,4) and the plane (P) orthogonal to said dummy rotation axis (5) is approximately of the order of between 8° and 10°.

17. Device (1) according to claim 2, in which the active area of each image sensor (22;32;42) is smaller than or is inscribed in a 4 mm by 3 mm area.

18. Device (1) according to claim 2 in which, for each lens group (2,3,4), the distance (d) between the front face of the head lens (21,31,41) and the image sensor (22,32,42) associated with said lens group (2,3,4) is less than or equal to 25 mm.

19. Device (1) according to claim 3, in which said angle of inclination (α) between the longitudinal axis (A₂,A₃,A₄) of each lens group (2,3,4) and the plane (P) orthogonal to said dummy rotation axis (5) is approximately of the order of between 8° and 10°.

20. Device (1) according to claim 3, in which the active area of each image sensor (22;32;42) is smaller than or is inscribed in a 4 mm by 3 mm area.
